(19) United States
(12) Patent Application Publication
(10) Pub. No.: US 2016/0337634 A1
(43) Pub. Date: Nov. 17, 2016

(54) DEVICE AND METHOD FOR GENERATING IMAGE INFORMATION FROM AN OBJECT TO BE CAPTURED

(71) Applicant: DR. WIRTH GRAFISCHE TECHNIK GMBH & CO. KG, Frankfurt am Main (DE)

(72) Inventor: Hans Huemoeller, Babenhausen (DE)

(21) Appl. No.: 15/109,300

(22) PCT Filed: Jan. 30, 2015
(86) PCT No.: PCT/DE2015/200051

§ 371 Date: Jun. 30, 2016

(30) Foreign Application Priority Data
Feb. 13, 2014 (DE) 10 2014 202 679.2

(51) Int. Cl. H04N 13/02

(52) U.S. Cl. CPC H04N 13/0253

(57) ABSTRACT

The invention relates to a device for generating image information from an object to be captured, particularly for reproducing said object two-dimensionally with a 3D appearance or sculptural effect, comprising an image capturing device for generating two-dimensional image information by scanning said object using a viewing beam path, and an illumination device for illuminating the object using an illuminating beam path, said image capturing device and illumination device being coupled such that the viewing and illuminating beam paths are moved synchronously over the object, the image capturing device being designed such that it scans, preferably with a predefinable overlap, one sub-region of the object after another, the illumination device having a reflector that comprises a, preferably diffusely, reflective reflection surface, and this reflection surface being arranged such that during scanning, said sub-region is indirectly illuminated by the lit reflection surface. The invention also relates to a corresponding method.

### CROSS REFERENCE TO RELATED APPLICATIONS

This application is a national stage application, filed under 35 U.S.C. §371, of International Application No. PCT/DE2015/200051, filed Jan. 30, 2015, which claims priority to German Application No. 10 2014 202 679.2, filed Feb. 13, 2014, the contents of both of which as are hereby incorporated by reference in their entirety.

### BACKGROUND

### Technical Field

The invention relates to a device for generating image information from an object to be captured, in particular, for reproducing said object two dimensionally with a 3D appearance or, more specifically, a sculptural effect.

Furthermore, the invention relates to a method for generating image information from an object to be captured, in particular, for reproducing said object two dimensionally with a 3D appearance or, more specifically, with a sculptural effect.

Devices and methods of the aforementioned type are well-known from the field and exist in various embodiments and variations. For example, there have been attempts in the decorative sector to depict shapes and surface structures as realistically as possible by means of two dimensional scan photography by taking advantage of the shadow that the structures cast when they are illuminated, in order to give a three dimensional impression of the surface structure in the context of the two dimensional representation. However, capturing the surface structures according to this method is extremely difficult and time consuming. In particular, lighting or, more specifically, illuminating the entire object in such a way that it is feasible to vividly illuminate the entire surface of the object to be scanned in the best possible way presents a problem.

### BRIEF SUMMARY

Therefore, the object of the present invention is to design and further develop a device and a method of the type, described in the introductory part, for generating image information from an object to be captured in such a way that an original object can be reproduced as realistically as possible, and, in particular, with a two dimensional representation that has a 3D appearance or, more specifically, a sculptured effect, where in this case the two dimensional image information can be generated with simple design features in an efficient manner.

The above object is achieved, according to the invention, by means of the features disclosed in patent claim 1, which discloses a device for generating image information from an object to be captured, in particular, for reproducing said object two dimensionally with a 3D appearance or, more specifically, a sculptural effect, said device comprising an image capturing device for generating two dimensional image information by scanning the object using a viewing beam path and an illumination device for illuminating the object using an illuminating beam path, said image capturing device and the illumination device being coupled in such a way that the viewing beam path and the illuminating beam path are moved synchronously over the object, the image capturing device being designed in such a way that it scans, preferably with a predefinable overlap, one subarea of the object after another, the illumination device having a reflector that comprises a reflective surface that reflects preferably more or less diffusely, and this reflective surface being arranged in such a way that when scanning, said subarea is indirectly illuminated by the spotlighted reflective surface.

Furthermore, the aforementioned object is achieved by means of the features disclosed in patent claim 20, which discloses a method for generating image information from an object to be captured, in particular, for reproducing said object two dimensionally with a 3D appearance or, more specifically, a sculptural effect, wherein in order to scan the object, a viewing beam path of an image capturing device and an illuminating beam path of an illumination device are moved synchronously over the object, the image capturing device scanning, preferably with a predefinable overlap, one subarea of the object after another, the scanned subareas being assembled into a composite image, the illumination device having a reflector that comprises a reflective surface that reflects preferably more or less diffusely, and, when scanning, said subarea is indirectly illuminated by the spotlighted reflective surface.

To begin with, it was first recognized in an inventive way that it is extremely advantageous for generating image information with the maximum degree of vividness possible if as uniform an illumination as possible can be achieved over the entire surface of the object to be scanned. For this purpose an image capturing device for generating two dimensional image information and an illumination device for illuminating the object are provided. According to the invention, the image capturing device and the illumination device are coupled to each other in such a way that the viewing beam path for scanning the object and the illuminating beam path for illuminating the object are moved synchronously and, as a result, jointly and concurrently, over the object, in particular, while maintaining the orientation of the beam paths. In this case the image capturing device is designed in such a way that it scans, preferably with a predefinable overlap, one subarea of the object after another using the viewing beam path. That is, the image capturing device scans successively another subarea or, more specifically, an additional subarea of the object. The individual subareas that are scanned may be assembled to form a complete scan and, thus, a two dimensional reproduction as the composite image of the object to be captured.

Thus, when scanning the object, each subarea can be treated exactly the same way in terms of the illumination and in terms of the viewing, since the distribution of the light intensity can be adjusted once for the subarea to the scanned and is then maintained for the entire scan of the object by means of the synchronous coupling of the viewing beam path and the illuminating beam path.

Furthermore, the illumination device comprises, according to the invention, a reflector having a reflective surface that reflects preferably diffusely, where in this case the reflective surface is arranged in such a way that the reflective surface, which is illuminated with light, indirectly illuminates the respective subarea to be scanned. Owing to the indirect illumination of the subarea to be scanned by means of the spotlighted reflective surface that reflects more or less diffusely, discrete light sources cannot be seen on the surface of the reflective objects. For example, individual light sources will not be visible when illuminating highly reflective gold jewelry, instead, only a diffusely reflecting wall will be seen. Furthermore, it should also be noted that in this context the term “diffusely” is defined as absolutely diffusely or with a weakly defined lobe.

Consequently, the inventive device and the inventive method for generating image information from an object to be captured are provided with a device and a method, which make it possible to generate a two dimensional image of the original object with simple design features in an efficient manner, so that the reproduction shows a high vividness, i.e., a 3D appearance.

In this context the term “object” is defined as a general geometric, three dimensional structure. In this case an object may denote one or more surfaces, one or more bodies and/or a space. The only aspect that is essential in this context is that an object is defined by surfaces that can be scanned. These surfaces may be flat, curved, structured, opaque, transparent, or may be designed in any other way.

At this point it should be noted that the expression “a subarea of the object to be scanned” may be construed to mean a partial surface of the object to be scanned, where in this case said partial surface may have a spatial or, more specifically, a three dimensional expansion/configuration due to, for example, its curvature or structuring.

In an advantageous manner at least one part of the image capturing device and/or the viewing beam path of the image capturing device can be arranged inside the reflector, preferably in the center or rather in the middle. As a result, the subarea of the object to be scanned could be illuminated all around on all sides.

In an additional advantageous manner the viewing beam path of the image capturing device may be designed so as to be tiltable or tilted relative to the plane of the object. As a result, the viewing beam path of the image capturing device allows the object to be scanned at an angle. At the same time it is conceivable that at least a part of the image capturing device can be arranged or oriented inside the reflector in such a way that the individual subareas of the object to be scanned can be scanned by scanning at an angle. The image capturing device can be designed specifically in such a way that the viewing beam path can be tilted from a perpendicular orientation relative to the plane of the object to an inclined orientation and then fixed. At the same time the viewing beam path remains advantageously perpendicular to the scanning direction of the device or, more specifically, the image capturing device. Thus, the oblique scan of the individual subareas of the object allows the additional use of the lateral sensor surface of a scan sensor for measuring the height or, more specifically, for measuring the altitude information. As a result, an object to be scanned can be stretched vertically in an advantageous manner and appears, due to the distortion of the geometry in the two dimensional reproduction, considerably more vivid than in the case of a vertical scan.

Furthermore, it is conceivable that the reflector surrounds or rather encloses at least partially the image capturing device and/or the viewing beam path of the image capturing device. This arrangement makes possible a particularly variable and comprehensive illumination or, more specifically, the spotlighting of the subarea to be scanned.

In an even more advantageous manner the reflective surface of the reflector may exhibit an essentially convex curvature in the three dimensional section in the direction of the subarea to be scanned of the object to be captured. Thus, by irradiating the reflective surface with light, preferably by means of light sources, arranged beneath the reflective surface, it is possible to achieve a particularly suitable distribution of the light intensity, which is directed onto the subarea to be scanned. The convex curvature of the reflective surface deflects upwards the light beams, impinging on the reflective surface. On the reflective surface the solid angles, extending from the light sources that are provided, illuminate downwards, due to the convex curvature, the areas on the reflective surface that become increasingly smaller and smaller, with the effect that the reflective surface becomes increasingly brighter, so that eventually the maximum light intensity is achieved on the reflective surface. Thereafter, the solid angles have to illuminate again larger areas on the reflective surface, so that the reflective surface becomes darker again.

In another advantageous manner, the curvature of the reflective surface can be designed so as to be at least partially circular, elliptical and/or straight. As a result, it is possible to influence, as a function of the selected curvature of the reflective surface, the intensity with which and the elevation angle, for example, more steep or more flat, from which the light beams of the illuminating beam path are supposed to impinge on the subarea to be scanned, after their deflection by the reflective surface. As a result, the sectional shape of the reflector determines in essence the illumination of the subarea as a function of the angle of elevation, when viewed from the direction of the subarea.

With respect to a suitable illumination of the object, for example, an illumination that is geared specifically towards the structural nature of the surface of the object to be scanned, the reflector can be designed in such a way that the cross sectional area of the reflector is extruded in the shape of a circle, an ellipse, or a straight line. Hence, a linear shape of the reflector, i.e., the cross sectional area of the reflector is extruded so as to be, in particular, linear, lends itself, in particular, to generating an image for a strictly and clearly straight grain of wood.

In an advantageous embodiment the reflector may be designed in the form of a rotational body having a rotational surface, wherein in this case the reflective surface of the reflector has an essentially convex curvature as the limit of the rotational surface in the direction of the subarea to be scanned or, more specifically, in the direction of the object to be captured. Thus, the reflector is a type of dome that allows flexible and multi-sided lighting, if desired, all around the subarea to be scanned.

With respect to the embodiment of the rotational body, the optical axis of the image capturing device can form the axis of rotation of the rotational body in an advantageous manner when the viewing beam path is oriented perpendicular to the plane of the object, i.e. when the object is scanned vertically.

In order to generate light for the illuminating beam path, the illumination device may include a lighting head with one or more light sources, where in this case the light sources radiate more or less in the direction of the reflective surface, so that the reflective surface redirects the light, emitted from the light sources, onto the object to be scanned or, more specifically, onto the subarea to be scanned of the object to be captured. For example, LEDs (light emitting diodes) are suitable as the light sources for spotlighting the reflective surface.

In an advantageous manner the lighting head may comprise a support for the arrangement of the light sources, said support being constructed in the form of a plate or a disk, and said support is designed so as to be open in the middle in such a way that the subarea of the object to be scanned is freely accessible to the viewing beam path and to the illuminating beam path, preferably through a corresponding opening.

In order to radiate the light in the direction of the reflective surface of the reflector, the light sources can be arranged on the support more or less in the form of one or more concentric circles, arcs and/or ellipses on the support.

With respect to a flexible lighting, the light sources can be engaged or disengaged and/or controlled individually and/or in groups. This arrangement makes it possible to influence, as a function of the actuation of the light sources, the azimuth angles and/or the elevation angles from which the subarea to be scanned is illuminated, in particular, with the maximum light intensity.

In an advantageous manner the lighting head may be disposed below the reflector.

With respect to a particularly simple adjustment of the illumination of the subarea, which is to be scanned, from a specific direction, the lighting head and/or the reflector can be rotated about the optical axis of the image capturing device, when the viewing beam path is oriented perpendicular to the object plane of the object. This arrangement makes it possible to adjust directly the azimuth angle of the illuminating beam path, when viewed from the subarea to be scanned.

With respect to a variable application, the illumination device, the lighting head and/or the reflector can be installed in the device in a changeable or easily replaceable manner. In this context it is conceivable in a particularly advantageous manner that the illumination device, the lighting head and/or the reflector is and/or are installed or fixed in the device by means of a clip, snap, plug, clamping and/or screw mechanism.

In a particularly advantageous manner the brightness of the illumination of the subarea to be scanned can be influenced or, more specifically, controlled by the shape of the reflective surface and the position of the light-emitting light sources.

With respect to the scanning of the object to be captured, the image capturing device may comprise a camera, for example, a color camera, with a scan sensor. In this case the scan sensor that may be used includes, for example, an area sensor, line sensor or point sensor. In an advantageous manner, each subarea to be scanned by the scan sensor can be illuminated and viewed in the same way.

With respect to generating a suitable image, the image capturing device or, more specifically, the camera may comprise telecentric optics, arranged preferably in a tube.

In the context of one exemplary embodiment of either the inventive device or the inventive method, individual contiguous subareas or partial surfaces of an object can be scanned and illuminated with a selectable overlap. In this case the subareas or, more specifically, the partial surfaces may be, depending on the scan sensor, small areas or small lines, which are combined to form a large line, transverse to the scanning direction. When an area chip is used as the scan sensor, an overlap takes place in an advantageous manner in the X direction and in the Y direction of the scan. If a line chip is used as the scan sensor, then only the total area of the continuously scanned large line is overlapped in the Y direction in an advantageous manner.

The overlap can be used to compensate for the disadvantages associated with the Bayer matrix, as long as no non-interpolating camera is used. Otherwise, any overlap increases the density range of the composite image, which is composed of the individual subareas covering the entire surface.

Another advantage of an overlap is to compensate for a fundamental disadvantage of area chips or line chips as the scan sensor. Flat sensor elements are always arranged side by side, so that there is routinely an undersampling during the scan. If the overlapping scan is not placed exactly on the pixels of the first scan, but rather in the middle between the previous pixels, then the copy will be scanned with greater completeness and accuracy.

If the scanning is done using an area chip without overlap, then the scan areas will be butt jointed and will form a continuous surface. If the goal is to achieve a 50 percent overlap, then the scanning is started not only at the beginning and the end of a subarea to be scanned, but also exactly in the middle of the subarea. The scan areas, started in the middle of the subarea, fit exactly together without a gap. Taking into consideration half the length of the subarea, leader and trailer at the beginning and end of a scan area line fit just as perfectly in the first and second scan area line. Furthermore, it is possible to overlap as often as desired. If at every 10 percent of the length of the subarea a new subarea strand is started, then the overlap amounts to 90 percent. Since the start of the subsequent scan can be adjusted arbitrarily, the result is an overlap that can be chosen at will.

With respect to the color of the light spectrum of the light sources, it should be noted that the white color may be composed of different white light sources. LEDs usually have, for example, wavelength-dependent dips in the white spectrum. It is possible to avoid extreme dips in the total spectrum by mixing the LEDs having dips that occur in other ranges of the spectrum. In order to be able to compensate for any remaining irregularities, profiler software may be used as part of a classic color management.

### BRIEF DESCRIPTION OF THE FIGURES

At this point there are a number of ways to design and further develop the teaching of the present invention in an advantageous manner. On the one hand, reference is made to the patent claims, subordinate to patent claim 1; and, on the other hand, reference is also made to the following explanations of the preferred exemplary embodiments of the invention based on the drawings. In conjunction with the elucidation of the preferred exemplary embodiments of the invention with reference to the drawings, preferred embodiments and further developments of the teaching are also explained in general. The drawings show in

FIG. 1 in schematic form a sectional view of an exemplary embodiment of a device according to the invention.

FIG. 2 in schematic form a sectional view of a simplified representation of the exemplary embodiment from FIG. 1 with the angle of elevation drawn in.

FIG. 3 in schematic form a plan view of a lighting head of the exemplary embodiment from either FIG. 1 or FIG. 2.

FIG. 4 in schematic form a plan view of the lighting head of the exemplary embodiment from FIG. 3 with the azimuth angle drawn in; and

FIG. 5 in schematic form a sectional view of an additional exemplary embodiment of an inventive device with a tiltable viewing beam path.

### DETAILED DESCRIPTION OF VARIOUS EMBODIMENTS

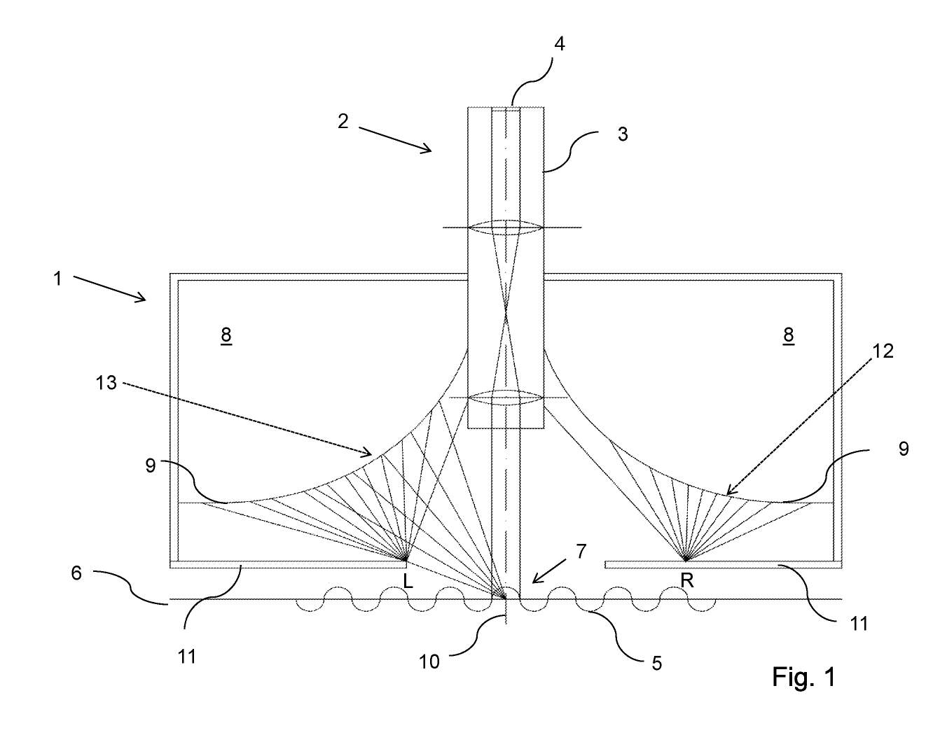

FIG. 1 shows in schematic form a sectional view of an exemplary embodiment of an inventive device with an illumination device 1 and a centrally disposed image capturing device 2. The image capturing device 2 comprises a tube 3 with viewing telecentric optics and a scan sensor 4 for scanning an object 5 having an object plane 6. The object 5 has a structured surface. The image capturing device 2 scans each subarea 7 of the object 5 one after the other in succession by means of the scan sensor 4 and the viewing optics. The total scan is composed of subareas that cover the entire area, where in this case a high degree of overlap or even multiple overlaps are possible.

The illumination device 1 comprises a reflector 8 having an essentially diffusely reflecting reflective surface 9, which is convexly curved relative to the object 5 or, more specifically, to the subarea 7. The reflector 8, shown in a sectional view in FIG. 1, is designed in the form of a rotational body having a rotational surface, where in this case the reflective surface 9 of the reflector 8 exhibits, as the limit of the rotational surface, the convex curvature in the direction of the subarea 7 to be scanned. When the tube 3 of the image capturing device 2 is in the vertical position, the optical axis 10 of the image capturing device 2 forms the axis of rotation of the rotational body or, more specifically, the reflector 8.

Below the reflective surface 9 there is a lighting head, which has a support 11 that is constructed as a disk. The support 11 has an opening in the middle, so that the subarea 7 to be scanned is freely accessible to both the viewing optics and, thus, to the viewing beam path, as well as also to the illuminating beam path. Two exemplary positions L and R of a light source can be seen on the support 11 in FIG. 1. The light source at the position R of the support 11 is positioned more towards the edge. The light source at the position L on the support 11 is oriented more towards the middle of the support 11.

The drawing shows the beams, which are emitted from both light sources, with solid angles that are spaced evenly apart from each other. With respect to the light source at the position R on the support 11 it can be seen in FIG. 1 that the upper part of the reflective surface 9 is no longer illuminated on the inside of the reflector 8. The convex curvature of the reflective surface 9 of the reflector 8 deflects the beams, which are emitted from the light source at the position R, in the upward direction.

On the reflective surface 9 the solid angles, extending from the light source at the position R, illuminate downwards, due to the convex curvature, the areas on the reflective surface 9 that become increasingly smaller, with the effect that said reflective surface 9 becomes increasingly brighter, so that eventually the maximum light intensity is achieved in a certain region 12 on the reflective surface 9. Thereafter, the solid angles have to illuminate again larger areas on the reflective surface 9, so that the reflective surface 9 becomes darker again towards the edge.

If the light source is arranged more towards the middle, i.e., according to the light source at the position L on the support 11, then those areas of the reflective surface 9 of the reflector 8 that are located even further in the upward direction are illuminated; and the maximum of the lighting intensity shifts more upward, i.e., into a region 13. Thus, the lighting structure (angle of elevation and distribution) is influenced and controlled by the shape of the changeable reflector 8 and by the position of the light sources or groups of light sources on the support 11, said light sources being positioned more or less outwardly or inwardly.

The positions and the distribution of the light sources on the support 11, together with the shape of the reflecting reflective surface 9 of the reflector 8, lead to a brightening of the subarea 7 to be scanned. Viewed from the direction of the subarea 7, there is a brightest point, for example, for a solid angle (azimuth angle 135°, elevation angle 45°). For larger or smaller azimuth angles and elevation angles, the brightness of the illumination decreases. If the normal of a subarea or, more specifically, a partial surface points in the direction of an azimuth angle of 135° and an elevation angle of 45°, then this subarea or, more specifically, this partial surface is maximally brightened. Surfaces with other angulations are less brightened and appear darker. Thus, the angle-dependent course of the brightness is controlled by the shape of the reflector and the arrangement of the light sources and/or their ability to engage and disengage.

The concentrated energizing of light sources for the solid angle (135° azimuth angle, 45° angle of elevation), when viewed from the direction of the subarea 7, leads, for example, to the classic vivid illumination from one direction with the correct course of the decrease of brightness at other angles.

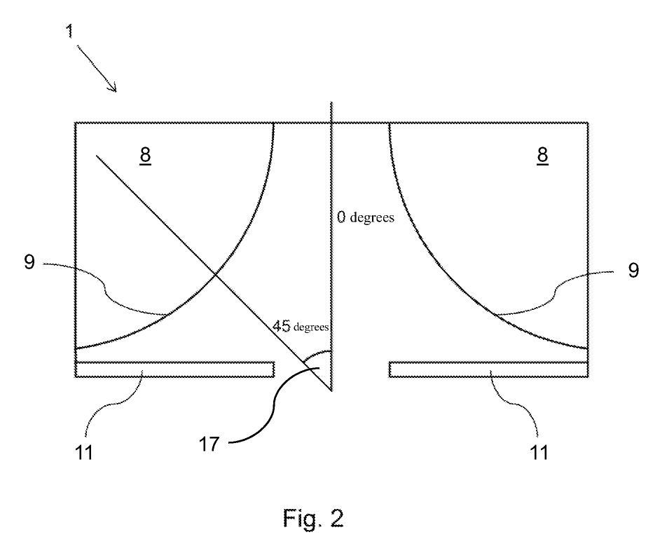

FIG. 2 shows in schematic form a sectional view of a simplified representation of the exemplary embodiment from FIG. 1 depicting an elevation angle 17 of 45° in relation to the optical axis 10 of the image capturing device 2. The intersection of the optical axis 10 of the image capturing device 2 with the object plane 6 of the object 5 in the subarea 7 to be scanned forms the vertex of the elevation angle 17 of 45°.

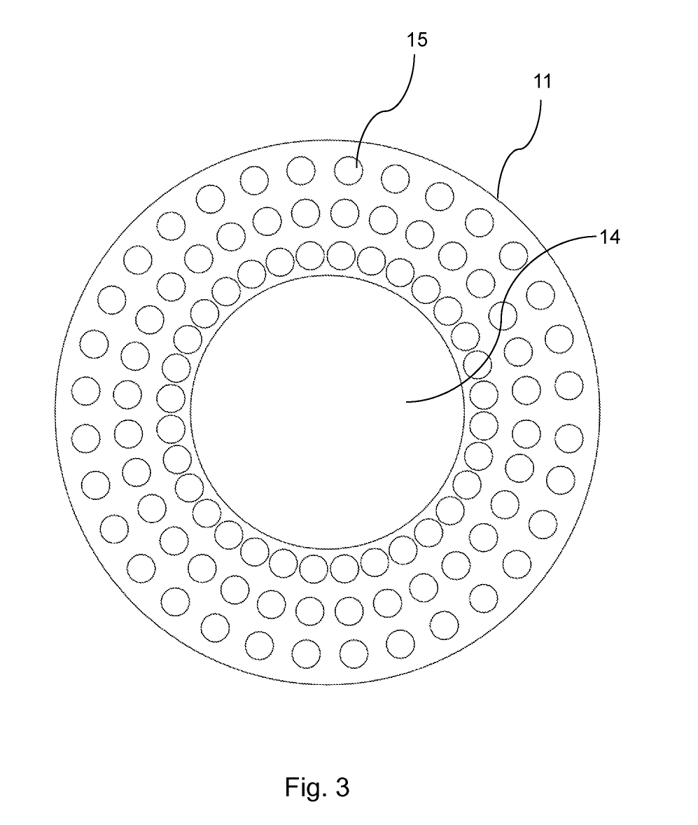

FIG. 3 shows in schematic form a plan view of a lighting head of the exemplary embodiment from either FIG. 1 or FIG. 2. The lighting head comprises a support 11, which is formed as a disk and which has an opening 14 in the middle. Furthermore, FIG. 3 shows in schematic form the arrangement of the light sources 15, for example, LEDs, in concentric rings. In this context it is also conceivable that the light sources are arranged in ellipses or form free shapes. Inner rings on the support 11 generate reflected light from steeper or rather greater angles of elevation; in contrast, outer rings generate preferably reflected light from shallower or, more specifically, smaller angles of elevation. The light sources can be switched individually, in groups or in any combinations. In this case the brightness is controlled by the pulse width and the pulse height, with the effect that continuous light is possible.

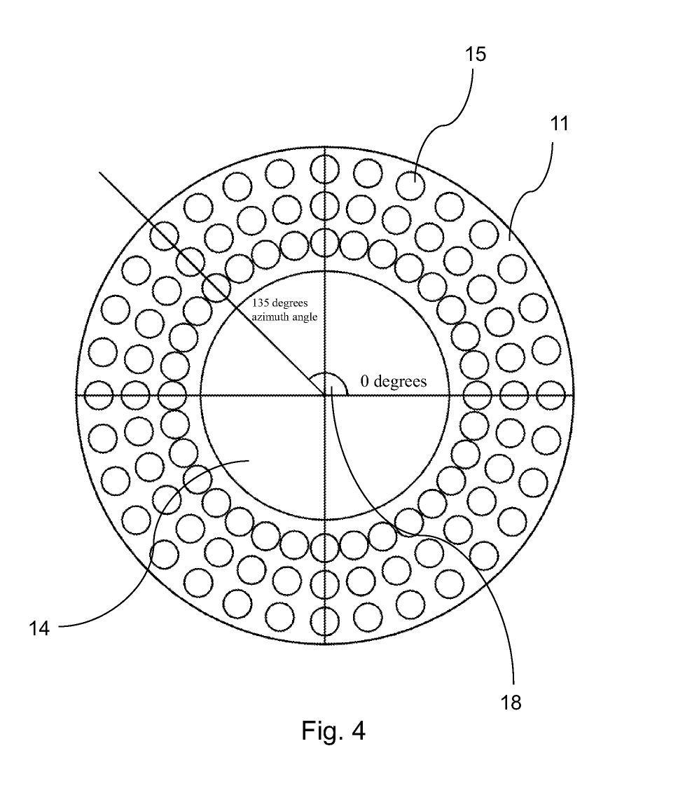

FIG. 4 shows in schematic form a plan view of the lighting head of the exemplary embodiment from FIG. 3 depicting an azimuth angle 18 of 135°.

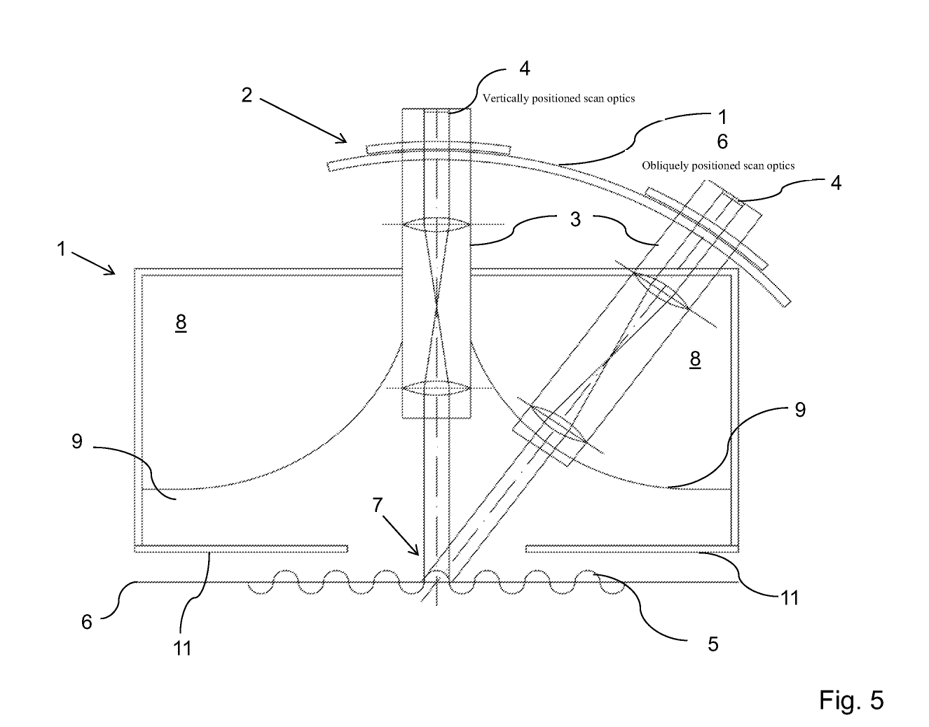

FIG. 5 shows in schematic form a sectional view of an additional exemplary embodiment of an inventive device with a tiltable viewing beam path. The image capturing device 2 comprises a tube 3, where in this case the tube 3 and, thus, the viewing beam can be positioned at an angle by means of an outer joint 16. This arrangement makes it possible to variably adjust and fix the tube 3 between a vertical position for vertical scanning and an oblique position for an oblique scan of the object. The use of a telecentric optical system permits structures of the subarea 7 that are located at varying distances, for example, are located at a greater distance or shorter distance, to be reproduced the same size. The result is that when the object 5 is scanned in succession, the structures of the object 5 to be scanned are reproduced at the same size and sharpness.

It can be seen in the region of the subarea 7 that owing to the angular position in the section plane, the subarea 7 to be scanned becomes larger in comparison to a vertical scan. Thus, the scan spot that is generated becomes asymmetrical. If the scan spot is not to be distorted again, then the image has to be so highly asymmetrically magnified until the useful field is reproduced true to scale again. The necessary magnification is calculated from the angle and with the trigonometric function. The subareas that are scanned by scanning at an angle fit together seamlessly to generate a composite image. The entire area of a lateral layer remains undistorted. If, for example, a round coin is placed flat on a scan area, then it will be reproduced, now as before, round like a circle. The height of the vertical edge is, for example, doubled; and the engraving on the top surface is significantly stretched vertically and appears to be considerably more vivid due to the distortion of the geometry.

In an advantageous manner at least one part of the image capturing device and/or the viewing beam path of the image capturing device can be arranged inside the reflector, preferably in the center or rather in the middle. As a result, the subarea of the object to be scanned could be illuminated all around on all sides.

In an additional advantageous manner the viewing beam path of the image capturing device may be designed so as to be tiltable or tilted relative to the plane of the object. As a result, the viewing beam path of the image capturing device allows the object to be scanned at an angle. At the same time it is conceivable that at least a part of the image capturing device can be arranged or oriented inside the reflector in such a way that the individual subareas of the object to be scanned can be scanned by scanning at an angle. The image capturing device can be designed specifically in such a way that the viewing beam path can be tilted from a perpendicular orientation relative to the plane of the object to an inclined orientation and then fixed. At the same time the viewing beam path remains advantageously perpendicular to the scanning direction of the device or, more specifically, the image capturing device. Thus, the oblique scan of the individual subareas of the object allows the additional use of the lateral sensor surface of a scan sensor for measuring the height or, more specifically, for measuring the altitude information. As a result, an object to be scanned can be stretched vertically in an advantageous manner and appears, due to the distortion of the geometry in the two dimensional reproduction, considerably more vivid than in the case of a vertical scan.

Furthermore, it is conceivable that the reflector surrounds or rather encloses at least partially the image capturing device and/or the viewing beam path of the image capturing device. This arrangement makes possible a particularly variable and comprehensive illumination or, more specifically, the spotlighting of the subarea to be scanned.

In an even more advantageous manner the reflective surface of the reflector may exhibit an essentially convex curvature in the three dimensional section in the direction of the subarea to be scanned of the object to be captured. Thus, by irradiating the reflective surface with light, preferably by means of light sources, arranged beneath the reflective surface, it is possible to achieve a particularly suitable distribution of the light intensity, which is directed onto the subarea to be scanned. The convex curvature of the reflective surface deflects upwards the light beams, impinging on the reflective surface. On the reflective surface the solid angles, extending from the light sources that are provided, illuminate downwards, due to the convex curvature, the areas on the reflective surface that become increasingly smaller and smaller, with the effect that the reflective surface becomes increasingly brighter, so that eventually the maximum light intensity is achieved on the reflective surface. Thereafter, the solid angles have to illuminate again larger areas on the reflective surface, so that the reflective surface becomes darker again.

In another advantageous manner, the curvature of the reflective surface can be designed so as to be at least partially circular, elliptical and/or straight. As a result, it is possible to influence, as a function of the selected curvature of the reflective surface, the intensity with which and the elevation angle, for example, more steep or more flat, from which the light beams of the illuminating beam path are supposed to impinge on the subarea to be scanned, after their deflection by the reflective surface. As a result, the sectional shape of the reflector determines in essence the illumination of the subarea as a function of the angle of elevation, when viewed from the direction of the subarea.

With respect to a suitable illumination of the object, for example, an illumination that is geared specifically towards the structural nature of the surface of the object to be scanned, the reflector can be designed in such a way that the cross sectional area of the reflector is extruded in the shape of a circle, an ellipse, or a straight line. Hence, a linear shape of the reflector, i.e., the cross sectional area of the reflector is extruded so as to be, in particular, linear, lends itself, in particular, to generating an image for a strictly and clearly straight grain of wood.

In an advantageous embodiment the reflector may be designed in the form of a rotational body having a rotational surface, wherein in this case the reflective surface of the reflector has an essentially convex curvature as the limit of the rotational surface in the direction of the subarea to be scanned or, more specifically, in the direction of the object to be captured. Thus, the reflector is a type of dome that allows flexible and multi-sided lighting, if desired, all around the subarea to be scanned.

With respect to the embodiment of the rotational body, the optical axis of the image capturing device can form the axis of rotation of the rotational body in an advantageous manner when the viewing beam path is oriented perpendicular to the plane of the object, i.e. when the object is scanned vertically.

In order to generate light for the illuminating beam path, the illumination device may include a lighting head with one or more light sources, where in this case the light sources radiate more or less in the direction of the reflective surface, so that the reflective surface redirects the light, emitted from the light sources, onto the object to be scanned or, more specifically, onto the subarea to be scanned of the object to be captured. For example, LEDs (light emitting diodes) are suitable as the light sources for spotlighting the reflective surface.

In an advantageous manner the lighting head may comprise a support for the arrangement of the light sources, said support being constructed in the form of a plate or a disk, and said support is designed so as to be open in the middle in such a way that the subarea of the object to be scanned is freely accessible to the viewing beam path and to the illuminating beam path, preferably through a corresponding opening.

In order to radiate the light in the direction of the reflective surface of the reflector, the light sources can be arranged on the support more or less in the form of one or more concentric circles, arcs and/or ellipses on the support.

With respect to a flexible lighting, the light sources can be engaged or disengaged and/or controlled individually and/or in groups. This arrangement makes it possible to influence, as a function of the actuation of the light sources, the azimuth angles and/or the elevation angles from which the subarea to be scanned is illuminated, in particular, with the maximum light intensity.

In an advantageous manner the lighting head may be disposed below the reflector.

With respect to a particularly simple adjustment of the illumination of the subarea, which is to be scanned, from a specific direction, the lighting head and/or the reflector can be rotated about the optical axis of the image capturing device, when the viewing beam path is oriented perpendicular to the object plane of the object. This arrangement makes it possible to adjust directly the azimuth angle of the illuminating beam path, when viewed from the subarea to be scanned.

With respect to a variable application, the illumination device, the lighting head and/or the reflector can be installed in the device in a changeable or easily replaceable manner. In this context it is conceivable in a particularly advantageous manner that the illumination device, the lighting head and/or the reflector is and/or are installed or fixed in the device by means of a clip, snap, plug, clamping and/or screw mechanism.

In a particularly advantageous manner the brightness of the illumination of the subarea to be scanned can be influenced or, more specifically, controlled by the shape of the reflective surface and the position of the light-emitting light sources.

With respect to the scanning of the object to be captured, the image capturing device may comprise a camera, for example, a color camera, with a scan sensor. In this case the scan sensor that may be used includes, for example, an area sensor, line sensor or point sensor. In an advantageous manner, each subarea to be scanned by the scan sensor can be illuminated and viewed in the same way.

With respect to generating a suitable image, the image capturing device or, more specifically, the camera may comprise telecentric optics, arranged preferably in a tube.

In the context of one exemplary embodiment of either the inventive device or the inventive method, individual contiguous subareas or partial surfaces of an object can be scanned and illuminated with a selectable overlap. In this case the subareas or, more specifically, the partial surfaces may be, depending on the scan sensor, small areas or small lines, which are combined to form a large line, transverse to the scanning direction. When an area chip is used as the scan sensor, an overlap takes place in an advantageous manner in the X direction and in the Y direction of the scan. If a line chip is used as the scan sensor, then only the total area of the continuously scanned large line is overlapped in the Y direction in an advantageous manner.

The overlap can be used to compensate for the disadvantages associated with the Bayer matrix, as long as no non-interpolating camera is used. Otherwise, any overlap increases the density range of the composite image, which is composed of the individual subareas covering the entire surface.

Another advantage of an overlap is to compensate for a fundamental disadvantage of area chips or line chips as the scan sensor. Flat sensor elements are always arranged side by side, so that there is routinely an undersampling during the scan. If the overlapping scan is not placed exactly on the pixels of the first scan, but rather in the middle between the previous pixels, then the copy will be scanned with greater completeness and accuracy.

If the scanning is done using an area chip without overlap, then the scan areas will be butt jointed and will form a continuous surface. If the goal is to achieve a 50 percent overlap, then the scanning is started not only at the beginning and the end of a subarea to be scanned, but also exactly in the middle of the subarea. The scan areas, started in the middle of the subarea, fit exactly together without a gap. Taking into consideration half the length of the subarea, leader and trailer at the beginning and end of a scan area line fit just as perfectly in the first and second scan area line. Furthermore, it is possible to overlap as often as desired. If at every 10 percent of the length of the subarea a new subarea strand is started, then the overlap amounts to 90 percent. Since the start of the subsequent scan can be adjusted arbitrarily, the result is an overlap that can be chosen at will.

With respect to the color of the light spectrum of the light sources, it should be noted that the white color may be composed of different white light sources. LEDs usually have, for example, wavelength-dependent dips in the white spectrum. It is possible to avoid extreme dips in the total spectrum by mixing the LEDs having dips that occur in other ranges of the spectrum. In order to be able to compensate for any remaining irregularities, profiler software may be used as part of a classic color management.

Finally, it is explicitly to be noted that the above described exemplary embodiments of either the inventive device or the inventive method are intended only to elucidate the claimed teaching, but do not limit said teaching to the exemplary embodiments.

### LIST OF REFERENCE NUMERALS AND SYMBOLS

1 illumination device
2 image capturing device
3 tube
4 scan sensor
5 object
6 object plane
7 subarea
8 reflector
9 reflective surface
10 optical axis
11 support
12 region of highest light intensity
13 region of highest light intensity
14 opening
15 light source
16 outer joint
17 angle of elevation
18 azimuth angle
L position L of a light source
R position R of a light source

1-20. (canceled)

21. Device for generating image information from an object to be captured, in particular, for reproducing said object two dimensionally with a 3D appearance or, more specifically, with a sculptural effect, said device comprising:
an image capturing device for generating two dimensional image information by scanning the object using a viewing beam path; and
an illumination device for illuminating the object using an illuminating beam path,
wherein:
the image capturing device and the illumination device are coupled in such a way that the viewing beam path and the illuminating beam path are moved synchronously over the object,
the image capturing device is designed in such a way that it scans one subarea of the object after another,
the illumination device has a reflector that comprises a reflective surface, and
the reflective surface is arranged in such a way that when scanning, the subarea is indirectly illuminated by the spotlighted reflective surface.

22. Device as claimed in claim 21, wherein at least one of the image capturing device or the viewing beam path of the image capturing device is at least partially disposed inside the reflector.

23. Device as claimed in claim 21, wherein the viewing beam path of the image capturing device is designed so as to be tiltable or tilted relative to the object plane.

24. Device as claimed in claim 21, wherein the reflector at least one of surrounds or encloses at least partially the image capturing device and/or the viewing beam path of the image capturing device.

25. Device as claimed in claim 21, wherein the reflective surface has an essentially convex curvature in the direction of the subarea to be scanned.

26. Device as claimed in claim 21, wherein the curvature of the reflective surface is designed so as to be at least one of partially partially circular, partially elliptical, or straight.

27. Device as claimed in claim 21, wherein the reflector is designed in such a way that the cross sectional area of the reflector is extruded in the shape of at least one of a circle, an ellipse, or a straight line.

28. Device as claimed in claim 21, wherein the reflector is designed in the form of a rotational body having a rotational surface, wherein the reflective surface of the reflector has an/the essentially convex curvature as the limit of the rotational surface in the direction of the subarea to be scanned.

29. Device as claimed in claim 28, wherein the optical axis of the image capturing device forms the axis of rotation of the rotational body, in particular, in the vertical orientation of the viewing beam path to the plane of the object.

30. Device as claimed in claim 21, wherein the illumination device comprises a lighting head with one or more light sources, in particular, LEDs, wherein the light sources radiate essentially in the direction of the reflective surface.

31. Device as claimed in claim 21, wherein the lighting head comprises a support for the arrangement of the light sources, said support being designed in the form of a plate or a disk, wherein said support is designed so as to be open in the middle in such a way that the subarea to be scanned is accessible to the viewing beam path and to the illuminating beam path.

32. Device as claimed in claim 21, wherein the light sources are arranged on the support essentially in the form of at least one of one or more concentric circles, one or more arcs, or one or more ellipses on the support.

33. Device as claimed in claim 21, wherein the light sources can be engaged or disengaged.

34. Device as claimed in claim 21, wherein the light sources can be controlled individually or in groups.

35. Device as claimed in claim 21, wherein the lighting head is arranged below the reflector.

36. Device as claimed in claim 21, wherein the lighting head and/or the reflector can be rotated about the optical axis of the image capturing device, in particular, when the viewing beam path is oriented perpendicular to the object plane.

37. Device as claimed in claim 21, wherein at least one of the illumination device, the lighting head, or the reflector is changeably installed in the device by means of at least one of a clip, a snap, a plug, a clamping mechanism, or a screw mechanism.

38. Device as claimed in claim 21, wherein the brightness illumination of the subarea to be scanned is controlled by the shape of the reflective surface and the position of the light sources.

39. Device as claimed in claim 21, wherein the image capturing device comprises a camera, in particular, a color camera, with a scan sensor, wherein the scan sensor is designed as an area sensor, line sensor or point sensor.

40. Device as claimed in claim 21, wherein the image capturing device or, more specifically, the camera comprises a telecentric optical system arranged in a tube.

41. Device as claimed in claim 21, wherein the image capturing device is designed to can the one subarea of the object after another with a predefinable overlap.

42. Device as claimed in claim 21, wherein the reflector comprises a diffusely reflecting reflective surface.

43. Method for generating image information from an object to be captured, in particular, with the use of a device, as claimed in claim 21, in particular, for reproducing said object two dimensionally with a 3D appearance or, more specifically, with a sculptural effect,
wherein in order to scan the object, a viewing beam path of an image capturing device and an illuminating beam path of an illumination device are moved synchronously over the object,
wherein the image capturing device scans one subarea of the object after another,
wherein the scanned subareas are assembled into a composite image,
wherein the illumination device comprises a reflector with a reflective surface, and
wherein when scanning, the subarea is indirectly illuminated by the spotlighted reflective surface.

44. Method as claimed in claim 43, wherein:
the image capturing device is designed in such a way that it scans the one subarea of the object after another with a predefinable overlap; and
the reflecting surface of the reflector is a diffusely reflecting reflective surface.
